(19) United States
(12) Patent Application Publication
(10) Pub. No.: US 2006/0015362 A1
(43) Pub. Date: Jan. 19, 2006

(54) Spatial data analyzing apparatus, spatial data analyzing method and spatial data analyzing program

(76) Inventors: Akihiko Nakase, Tokyo (JP); Hisaaki Hatano, Kanagawa-Ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/080,619

(22) Filed: Mar. 16, 2005

(30) Foreign Application Priority Data
Jul. 16, 2004 (JP) 2004-209977

(51) Int. Cl. G06Q 99/00

(52) U.S. Cl. 705/1; 705/7

(57) ABSTRACT

This apparatus, method, and program, from a plurality of records each record including position information showing a position in a two or more-dimensional space and a plurality of attribute information pieces, finds a condition of attribute information under which records are congested in the space, including: selecting records having same attribute information piece from the plurality of records for each of attribute information pieces; storing the attribute information piece in case where the records selected satisfy a predetermined congestion condition based on the position information of the records selected; combining attribute information pieces stored among different attributes to generate a combination of attribute information pieces; selecting records having the combination of attribute information pieces from the plurality of records; and storing the combination of attribute information pieces in case where the records selected satisfy the predetermined congestion condition based on the position information of the records selected.

### CROSS-REFERENCE TO RELATED APPLICATIONS

This application claims the benefit of priority under 35USC 119 to Japanese Patent Application No. 2004-209977, filed on Jul. 16, 2004, the entire contents of which are incorporated herein by reference.

### BACKGROUND OF THE INVENTION

1. Field of the Invention

The present invention relates a spatial data analyzing apparatus, spatial data analyzing method and spatial data analyzing program.

2. Related Background Art

In recent years, much spatial data having position information pieces and attribute information pieces is accumulated according to advance of GPS (Global Positioning System), sensor network or the like.

When the spatial data is analyzed and such a regularity as “a place where data items satisfying a certain condition (data items having a certain attribute information piece or a certain combination of attribute information pieces) are congested” can be found, since it is expected that data items satisfying the regularity are congested at a certain specific place in the future, an effective measure can be taken in advance.

However, in order to find a correlation between attribute information pieces and congestion states, it is necessary to select data items corresponding to each of all attribute information pieces and all combinations of attribute information pieces to determinate about a congestion state, which results in requirement for much computation time.

In view of these circumstances, JP-A-2003-256757 has proposed an approach which finds conditions of attribute information pieces under which data items is congested (attribute information pieces and combinations of attribute information pieces), while reducing the number of times required for determination.

In the approach, however, in the case where an attribute information piece by which a congestion state is not formed exists, there is a problem that it is difficult to find a classification rule (regulation) including the attribute of the attribute information piece.

### BRIEF DESCRIPTION OF THE DRAWINGS

FIG. 1 is a functional block diagram of a spatial data analyzing apparatus according to an embodiment of the present invention;

FIGS. 2A and 2B are one example where “sex=female” has been selected from a traffic accident occurrence record data;

FIGS. 3A and 3B are one example where “sex=male” has been selected from the traffic accident occurrence record data;

FIGS. 4A and 4B are one example where “age=young” has been selected from the traffic accident occurrence record data;

FIGS. 5A and 5B are one example where “age=older” has been-selected from the traffic accident occurrence record data;

FIGS. 6A and 6B are one example where “weather=fair” has been selected from the traffic accident occurrence record data;

FIGS. 7A and 7B are one example where “weather=rainy” has been selected from the traffic accident occurrence record data;

FIGS. 8A and 8B are one example where “weather=snow” has been selected from the traffic accident occurrence record data;

FIGS. 9A and 9B are one example where “sex=female and age=older” has been selected from the traffic accident occurrence record data;

FIGS. 10A and 10B are one example where “sex=male and age=older” has been selected from the traffic accident occurrence record data;

FIGS. 11A and 11B are one example where “sex=female and weather=snow” has been selected from the traffic accident occurrence record data;

FIGS. 12A and 12B are one example where “sex=male and weather=snow” has been selected from the traffic accident occurrence record data;

FIGS. 13A and 13B are one example where “age=older and weather=snow” has been selected from the traffic accident occurrence record data;

FIG. 14 is a flowchart showing processing steps performed by the spatial data analyzing apparatus shown in FIG. 1;

FIG. 15 is one example of traffic accident occurrence record data; and

FIG. 16 is a diagram showing plotting of the traffic accident occurrence record data shown in FIG. 15 on a two-dimensional plane.

### SUMMARY OF THE INVENTION

According to an aspect of the present invention, there is provided a spatial data analyzing apparatus which, from a plurality of records each record including position information showing a position in a two or more-dimensional space and a plurality of attribute information pieces belonging to a plurality of attributes, finds a condition of attribute information under which records are congested in the space, comprising: a first data selecting unit which selects records having same attribute information piece from the plurality of records for each of attribute information pieces; a first determining unit which stores the attribute information piece corresponding to the records selected in case where the records selected satisfy a predetermined congestion condition based on the position information of the records selected; a combination data generating unit which combines attribute information pieces stored among different attributes to generate a combination of attribute information pieces; a second data selecting unit which selects records having the combination of attribute information pieces from the plurality of records; and a second determining unit which stores the combination of attribute information pieces corresponding to the records selected by the second data selecting unit in case where the records selected satisfy the predetermined congestion condition based on the position information of the records selected.

According to an aspect of the present invention, there is provided a spatial data analyzing method which, from a plurality of records each record including position information showing a position in a two or more-dimensional space and a plurality of attribute information pieces belonging to a plurality of attributes, finds a condition of attribute information under which records are congested in the space, comprising: selecting records having same attribute information piece from the plurality of records for each of attribute information pieces; storing the attribute information piece corresponding to the records selected in case where the records selected satisfy a predetermined congestion condition based on the position information of the records selected; combining attribute information pieces stored among different attributes to generate a combination of attribute information pieces; selecting records having the combination of attribute information pieces from the plurality of records; and storing the combination of attribute information pieces corresponding to the records selected in case where the records selected satisfy the predetermined congestion condition based on the position information of the records selected.

According to an aspect of the present invention, there is provided a spatial data analyzing program which, from a plurality of records each record including position information showing a position in a two or more-dimensional space and a plurality of attribute information pieces belonging to a plurality of attributes, finds a condition of attribute information under which records are congested in the space, the spatial data analyzing program causing a computer to execute: a first data selecting step selecting records having same attribute information piece from the plurality of records for each of attribute information pieces; a first determining step storing the attribute information piece corresponding to the records selected in case where the records selected satisfy a predetermined congestion condition based on the position information of the records selected; a combination data generating step combining attribute information pieces stored among different attributes to generate a combination of attribute information pieces; a second data selecting step selecting records having the combination of attribute information pieces from the plurality of records; and a second determining step storing the combination of attribute information pieces corresponding to the records selected by the second data selecting step in case where the records selected satisfy the predetermined congestion condition based on the position information of the records selected.

### DETAILED DESCRIPTION OF THE INVENTION

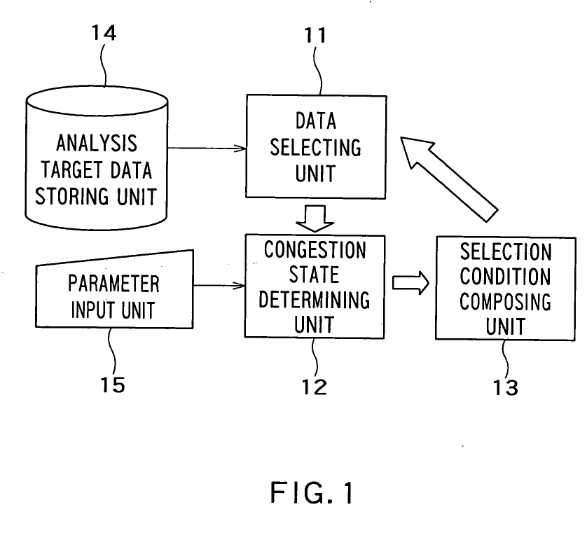

FIG. 1 is a functional block diagram of a spatial data analyzing apparatus according to an embodiment of the present invention.

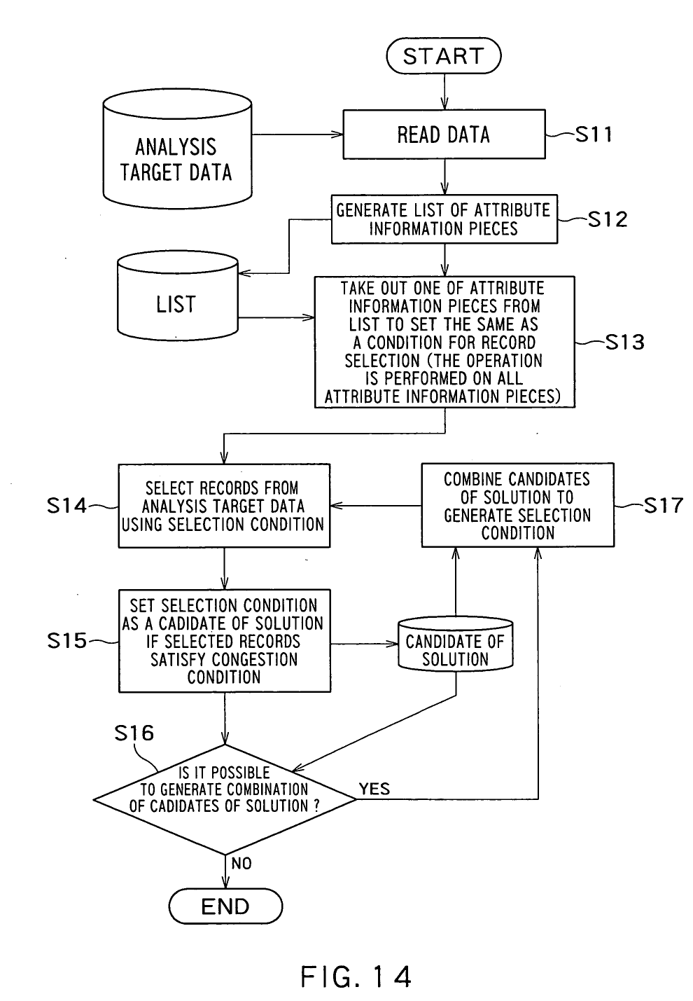

FIG. 14 is a flowchart showing processing steps performed by the spatial data analyzing apparatus shown in FIG. 1.

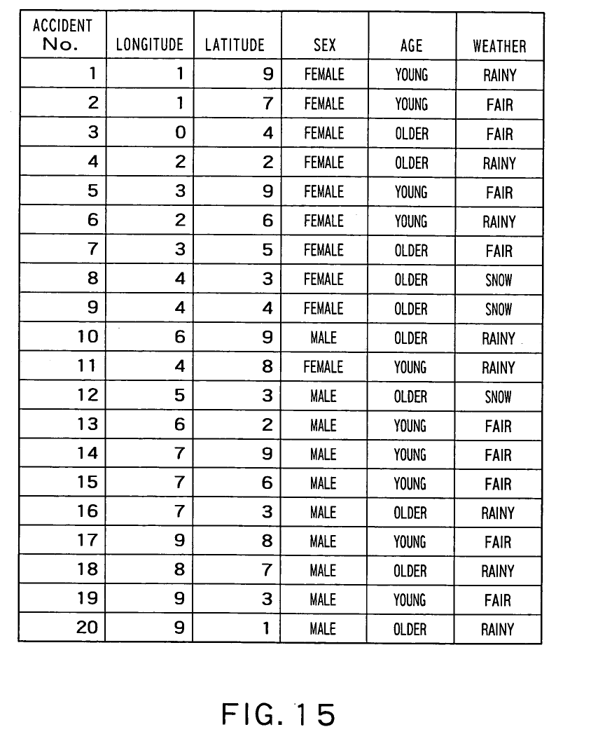

FIG. 15 is a table showing traffic accident occurrence record data as an example of data items to be analyzed by the spatial data analyzing apparatus shown in FIG. 1.

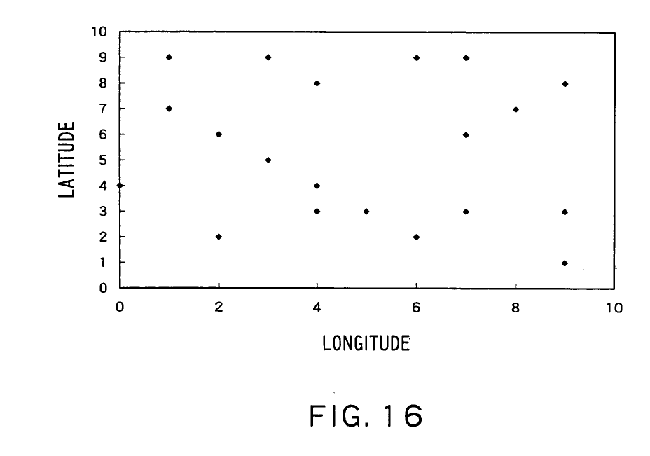

FIG. 16 is a distribution diagram showing plotting of the traffic accident occurrence record data shown in FIG. 15 on a two-dimensional plane.

As shown in FIG. 15, traffic accident occurrence record data includes attribute information pieces showing sex and age of a driver, and a weather of that day, in addition of position information about the latitude and the longitude of a point of occurrence of a traffic accident. In detail, two attribute information pieces of male and female are included as sex of a driver, two attribute information pieces of young and older are included as age of a driver, and three attribute information pieces of fair, rainy, and snow are included as weather of that day.

A spatial data analyzing apparatus shown in FIG. 1 analyzes data (record group) including position information pieces and attribute information pieces such as the traffic accident occurrence record data to find attribute information pieces or a combination(s) of the attribute information pieces where records are spatially clustered close together (find attribute information pieces or a combination(s) of the attribute information pieces satisfying a congestion condition).

First, basic configuration and operation of the spatial data analyzing apparatus will be explained with reference to FIG. 1 and FIG. 14.

(1) A data selecting unit 11 shown in FIG. 1 reads analysis target data (for example, traffic accident occurrence record data) which is stored in an analysis target data storing unit 14 (Step S11) to generate a list of attribute information pieces (for example, “female”, “male”, “young”, “older”, “fair”, “rainy”, and “snow”) (Step S12).

The data selecting unit 11 extracts one attribute information piece from the list of the attribute information pieces (Step S13), and selects records including the extracted attribute information piece from the analysis target data (Step S14). That is, the data selecting unit 11 selects records from the analysis target data using the extracted attribute information piece as a selection condition. The data selecting unit 11 performs this processing on all the attribute information pieces. That is, for example, the data selecting unit 11 selects all records including the attribute information piece “female”, selects all records including the attribute information piece “male”, and selects all records including the attribute information piece “young” and so on.

(2) A congestion state determining unit 12 determines whether or not a group of records selected by data selecting unit 11 satisfies a predetermined congestion condition for each of the attribute information pieces, and it stores the attribute information piece as a candidate of a solution when the attribute information piece satisfies the predetermined congestion condition (Step S15).

Particularly, the congestion state determining unit 12 calculates a center of gravity of the record group based upon a position information piece of respective records constituting the record group. Next, the congestion state determining unit 12 calculates a congestion degree (described later) based upon the calculated center of gravity and the position information of respective records. The congestion state determining unit 12 determines whether or not the calculated congestion degree satisfies a criteria based upon a congestion state determining parameter(s) inputted from a parameter input unit 15. When the calculated congestion degree satisfies the criteria, the congestion state determining unit 12 selects the attribute information piece as a candidate of a solution. The selected attribute information piece (a candidate of solution) is stored together with the center of gravity and the congestion degree. The stored attribute information piece, center of gravity, and congestion degree are outputs of the spatial data analyzing apparatus.

(3) A selection condition composing unit 13 combines attribute information pieces satisfying the predetermined congestion condition, which are selected by the congestion state determining unit 12, among different attributes to generate a combination of the attribute information pieces. The selection condition composing unit 13 passes the generated combination of the attribute information pieces to the data selecting unit 11 (Yes in Step S16, Step S17).

(4) The data selecting unit 11 selects records including the passed combination of the attribute information pieces from the analysis target data (Step S14).

(5) The congestion state determining unit 12 determines whether or not the selected records (record group) satisfies the above predetermined congestion condition. When the record group satisfies the above predetermined congestion condition, the congestion state determining unit 12 stores the combination of the attribute information pieces as a candidate of a solution (Step S15).

In particular, the congestion state determining unit 12 calculates a center of gravity of the record group including the selected combination of the attribute information pieces and the congestion degree thereof such as the above. When the calculated congestion degree satisfies the criteria based upon the above-described congestion state determining parameter(s), the congestion state determining unit 12 stores the combination of the attribute information pieces as a candidate of a solution together with the center of gravity and the congestion degree. The stored combination of attribute information pieces, center of gravity, and congestion degree are outputs of the space data analyzing apparatus.

(6) The selection condition composing unit 13 combines the selected combination of the attribute information pieces and the attribute information piece previously selected by the congestion state determining unit 12 such that equal attributes do not overlap with each other to generate a new combination of attribute information pieces (Yes in Step S16, Step S17). The selection condition composing unit 13 passes the new combination of the attribute information pieces to the date selecting unit 11 (Step S17).

Thereafter, the above items (4) to (6) are repeated until a combination of attribute information pieces can not be generated by the selection condition composing unit 13 (No in Step S16).

A case that the traffic accident occurrence record data shown in FIG. 15 is analyzed to find attribute information pieces and a combination(s) thereof which satisfy the congestion condition by using the spatial data analyzing apparatus shown in FIG. 1 will be explained as a concrete example.

First, the data selecting unit 11 selects records from the traffic accident occurrence record data shown in FIG. 15 as analysis target data by using attribute information pieces of respective attributes (sex, age, and weather) as selection conditions.

That is, records including “sex=female”, “sex=male”, “age=young”, “age=older”, “weather=fair”, “weather=rainy”, and “weather=snow” are selected from the analysis target data shown in FIG. 15, respectively.

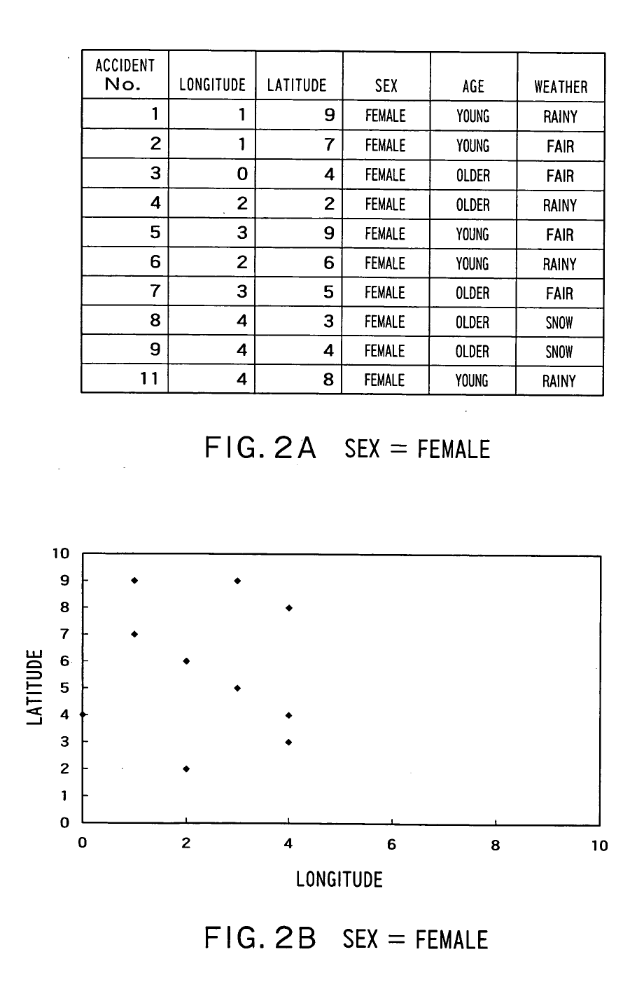

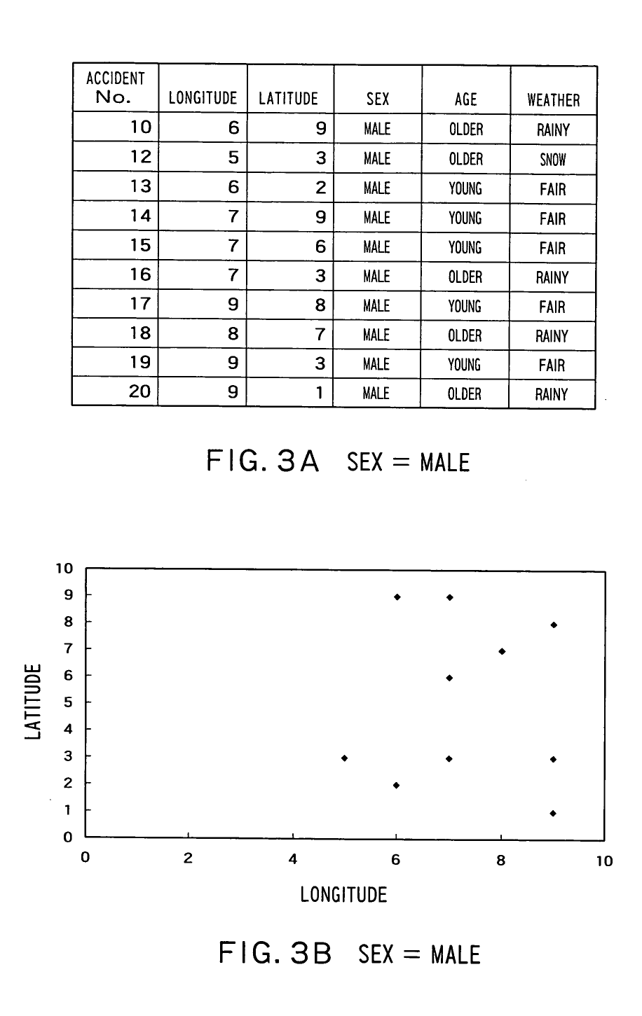

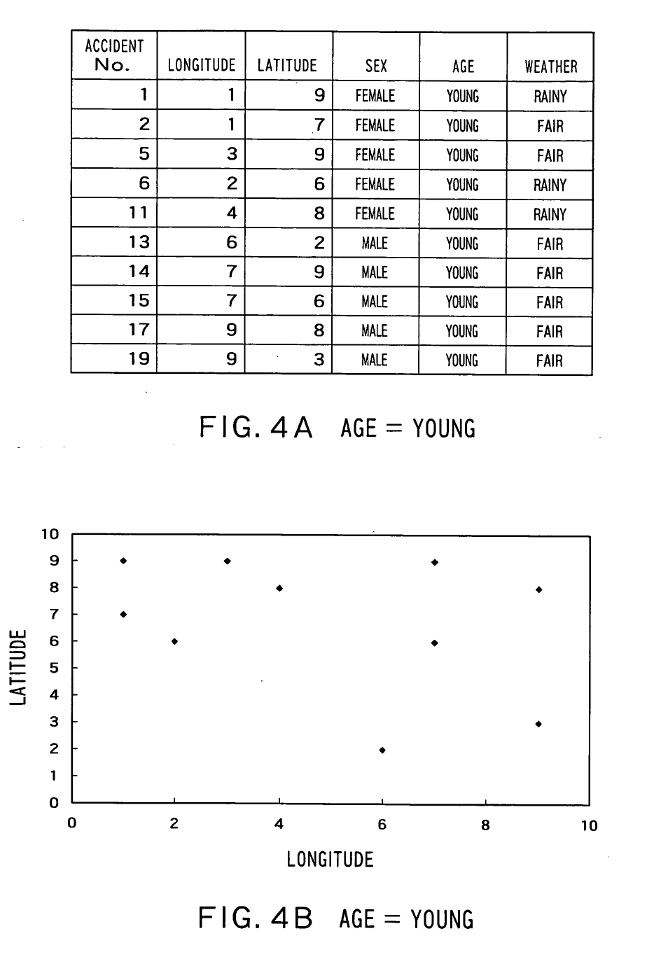

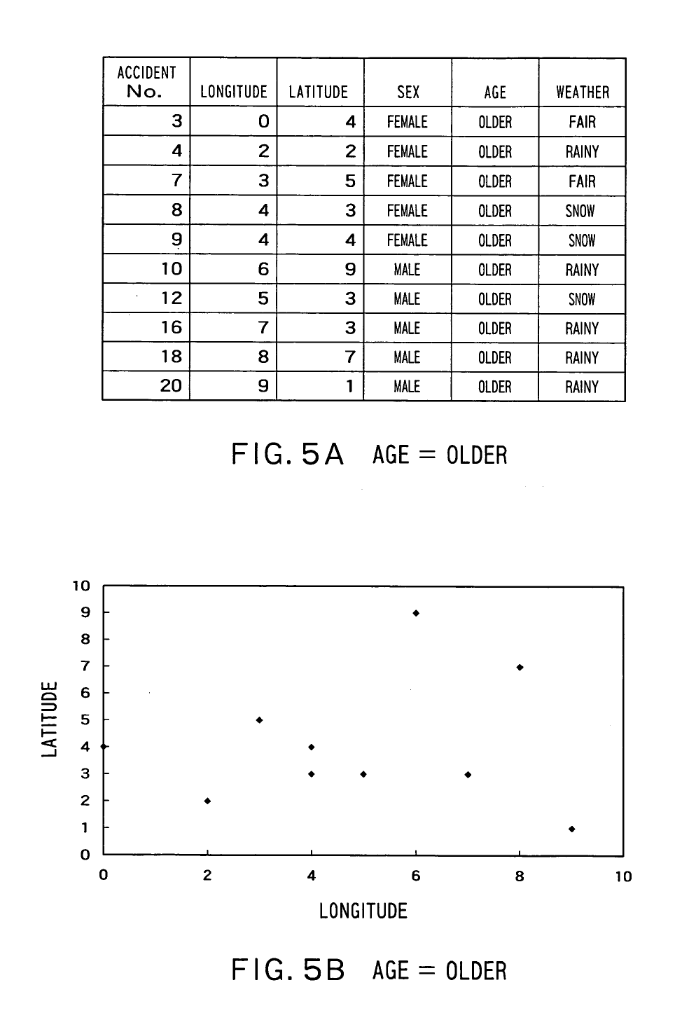

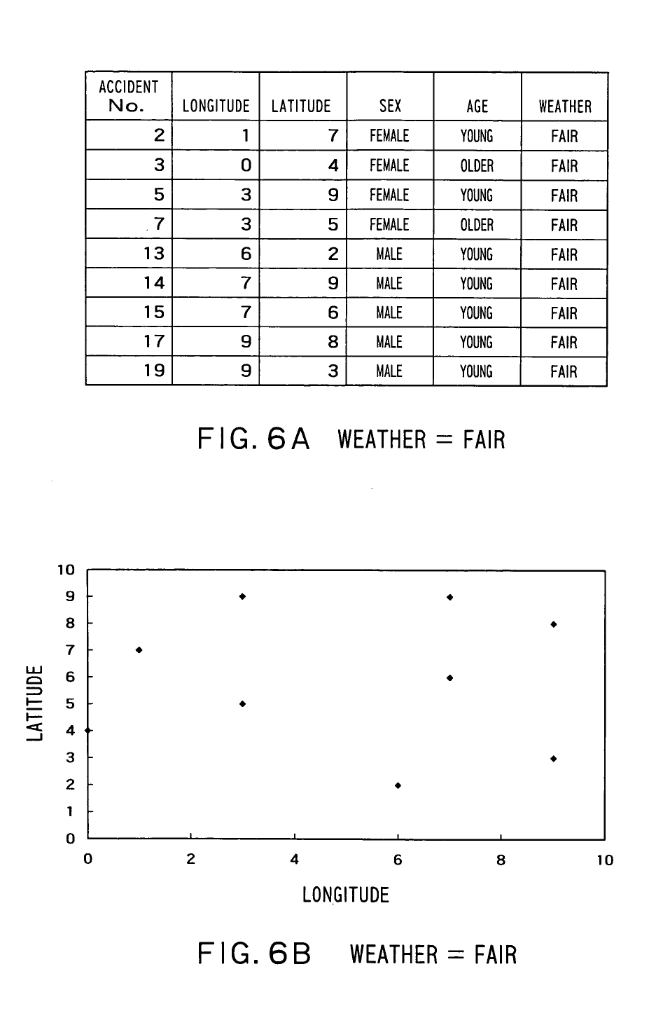

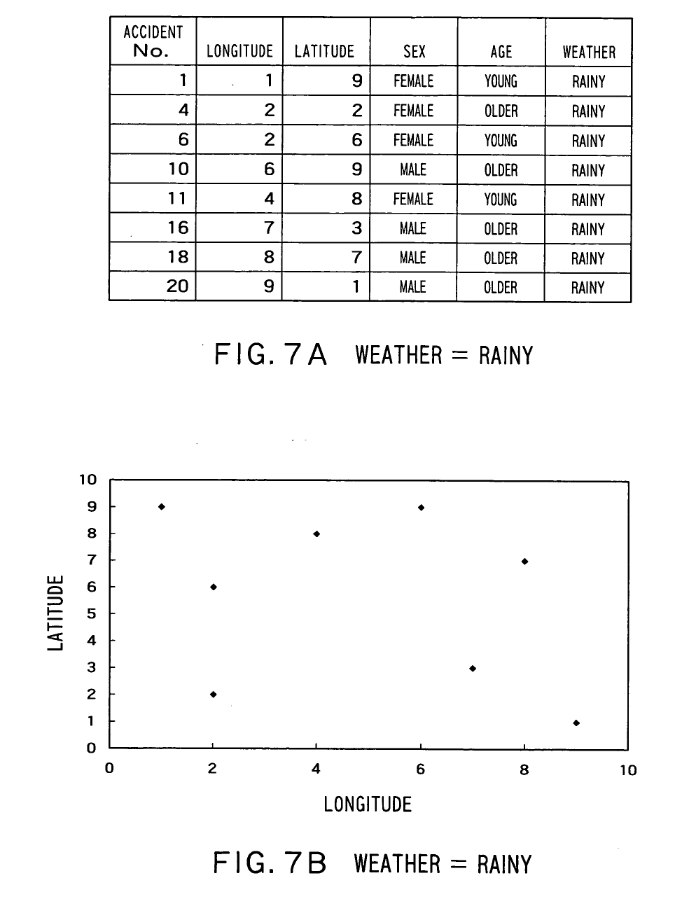

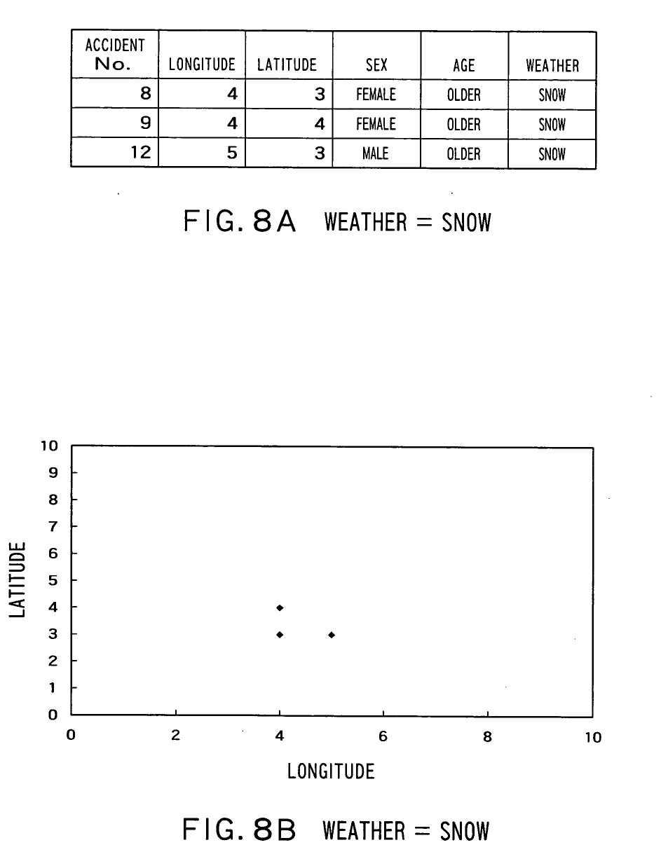

Record groups selected based upon respective attribute information piece (“sex=female”, “sex=male”, “age=young”, “age=older”, “weather=fair”, “weather=rainy”, and “weather=snow”) and aspects where positions of records constituting the respective record groups have been plotted on a two-dimensional map are shown in FIGS. 2A and 2B through FIGS. 8A and 8B.

Determination is then made in the congestion state determining unit 12 shown in FIG. 1 about whether or not respective record groups selected based upon the above-described seven attribute information pieces (selection conditions) constitutes congestion in a space (in this example, a two-dimensional space defined by a horizontal axis corresponding to the longitude and a vertical axis corresponding to the latitude) (whether or not each record group satisfies a predetermined congestion condition). Determination about whether or not each record group satisfies the congestion condition is made by calculating a congestion degree to determine whether or not the calculated congestion degree satisfy a criteria based upon a parameter(s) inputted from the parameter input unit 15 by a user.

In this embodiment, the congestion degree is defined as a value obtained by dividing the sum of the squares of distances from the center of gravity of a record group (an average of longitudes and latitudes of respective records constituting the record group) to positions (the longitudes and the latitudes) of respective records by the number of records. For example, a state that the congestion degree is 12.5 (a thresholder inputted as the parameter by a user) or less is defined as a congestion state. Incidentally, the minimum number of records constituting congestion is defined as 2 (which is inputted as the parameter by a user). In other words, regarding one record group, when the congestion degree is 12.5 or less and the number of records is 2 or more, the one record group satisfies the congestion condition.

Now, regarding respective record groups selected based upon the attribute information pieces of the above-described “sex=female”, “sex=male”, “age=young”, “age=older”, “weather=fair”, “weather=rainy”, and “weather=snow”, the congestion state determining unit 12 first calculates the number of records, the center of gravity, and the congestion degree which correspond to each attribute information piece, and the like. The calculation results are shown in the following Table 1.

TABLE 1

| | | | sum of | |
|---|---|---|---|---|
| | | | squares of | |
| Attribute | number | | distances | |
| information | of | center of | from center | congestion |
| piece | records | gravity | of gravity | degree |
| “sex = female” | 10 | (2.4, 5.7) | 74.5 | 7.45 |
| “sex = male” | 10 | (7.3, 5.1) | 101.0 | 10.1 |
| “age = young” | 10 | (4.9, 6.7) | 143.0 | 14.3 |
| “age = older” | 10 | (4.8, 4.1) | 120.5 | 12.05 |
| “weather = rainy” | 8 | (4.875, 5.625) | 136.75 | 17.09375 |
| “weather = fair” | 9 | (5.0, 5.89) | 142.89 | 15.88 |
| “weather = snow” | 3 | (4.33, 3.33) | 1.33 | 0.44 |

From Table 1, the attribute information pieces where the congestion degree is 12.5 or less and the number of records is 2 or more, namely, the attribute information pieces satisfying the congestion condition are four pieces of “sex=female”, “sex=male”, “age=older”, and “weather=snow”, and the four attribute information pieces and data items corresponding thereto (the number of records, center of gravity, sum of squares of distances from the center of gravity, and congestion degree) are stored in the congestion state determining unit 12. The attribute information pieces stored are passed to the selection condition composing unit 13 shown in FIG. 1.

The selection condition composing unit 13 combines the attribute information pieces passed from the congestion state determining unit 12 between different attributes to generate a combination(s) of the attribute information pieces. That is, the selection condition composing unit 13 ANDs two attribute information pieces between attributes different from each other.

In other words, in this example, the selection condition composing unit 13 generates five combinations of attribute information pieces i.e. “sex=female and age=older”, “sex=male and age=older”, “sex=female and weather=snow”, “sex=male and weather=snow”, and “age=older and weather=snow” based upon the four passed attribute information pieces (“sex=female”. “sex=male”, “age=older”, and “weather=snow”).

The five combinations (selection conditions) of the attribute information pieces generated are passed from the selection condition composing unit 13 to the data selecting unit 11 shown in FIG. 1. The data selecting unit 11 selects records from the traffic accident occurrence record data shown in FIG. 15 based upon the respective selection conditions (“sex=female and age=older”, “sex=male and age=older”, “sex=female and weather=snow”, “sex=male and weather=snow”, and “age=older and weather=snow”).

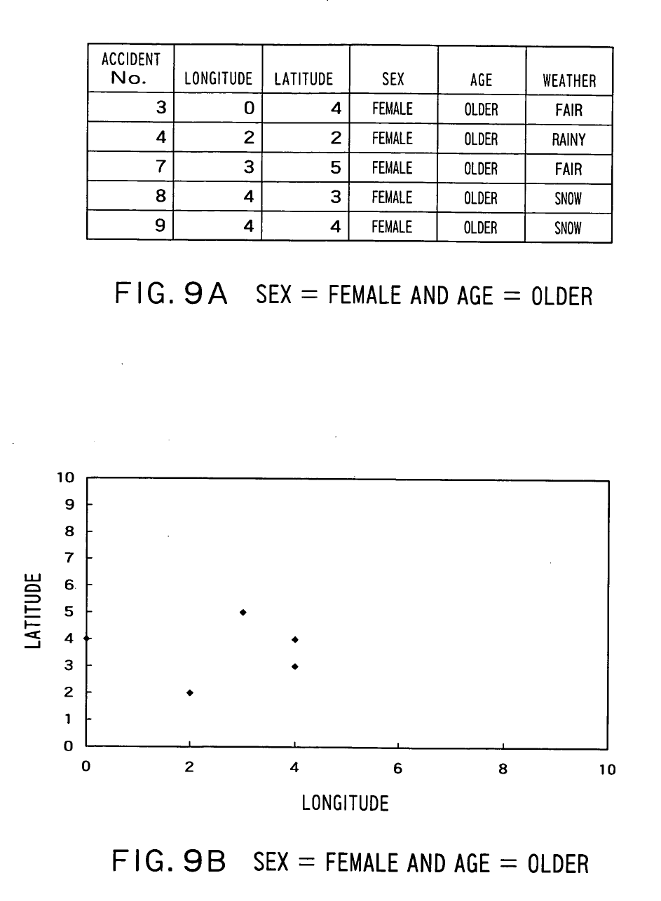

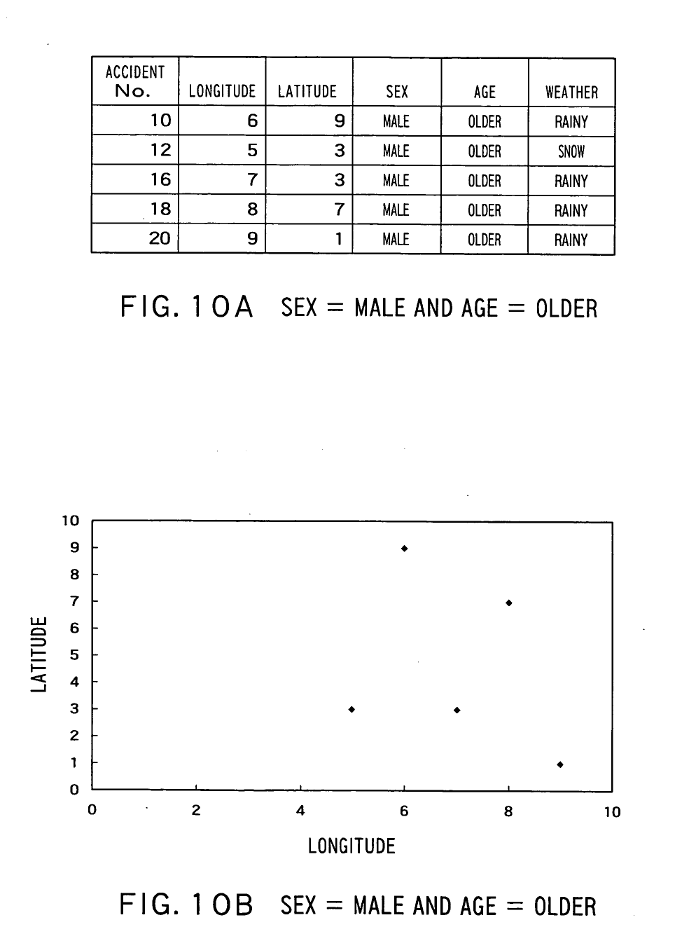

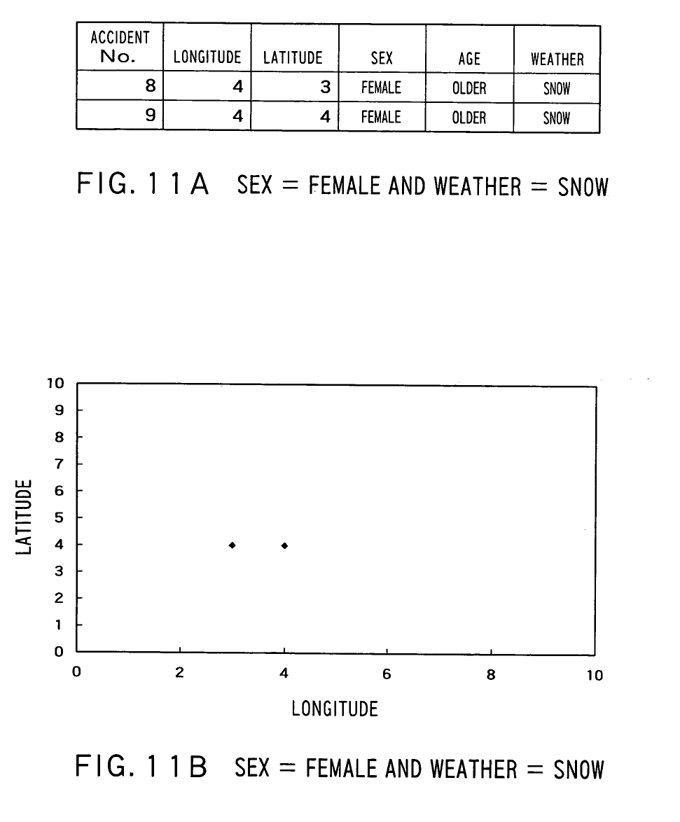

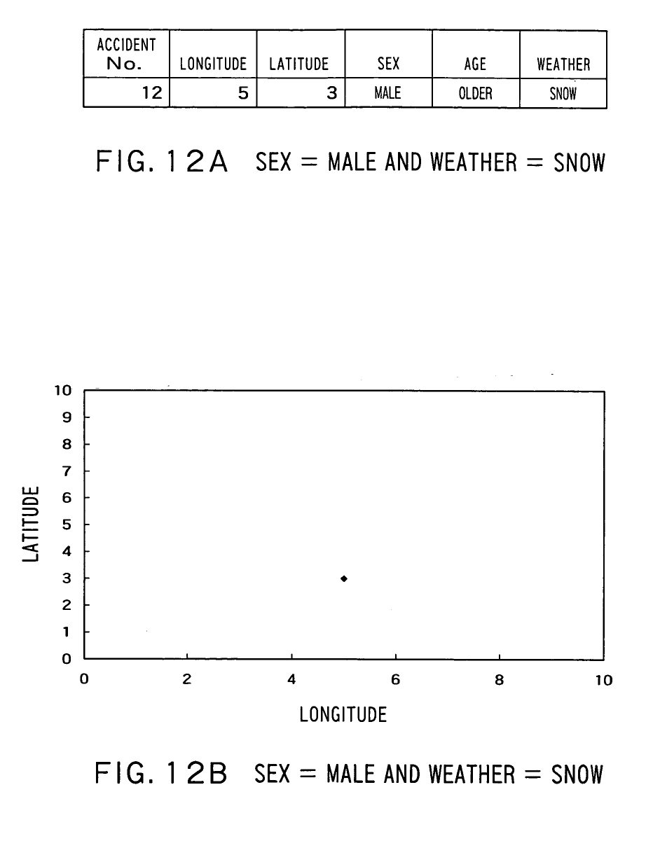

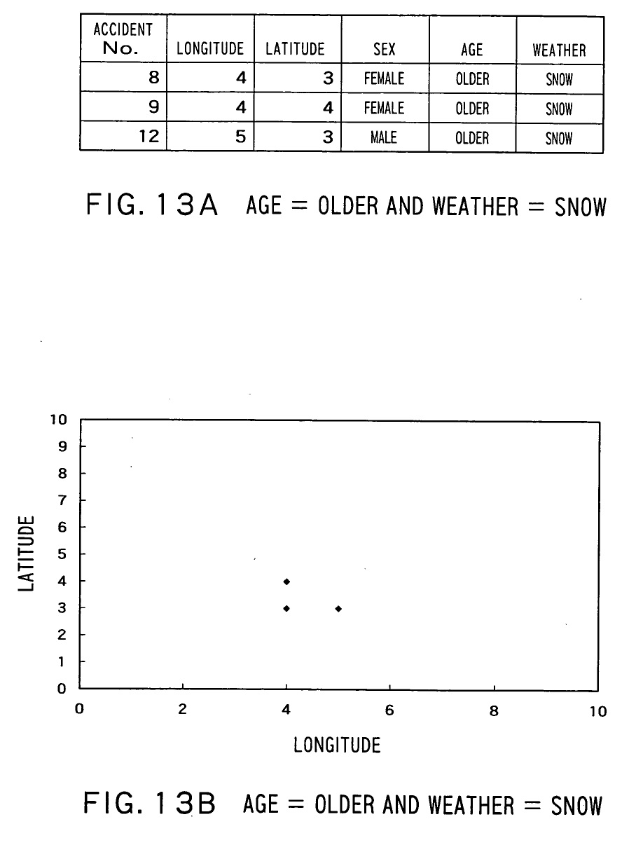

The respective record groups selected based upon the selection conditions (“sex=female and age=older”, “sex=male and age=older”, “sex=female and weather=snow”, “sex=male and weather=snow”, and “age=older and weather=snow”) and aspects where positions of records constituting the respective record groups are plotted on a two-dimensional map are shown in FIGS. 9A and 9B to FIGS. 13A to 13B.

The congestion state determining unit 12 shown in FIG. 1 makes determination about whether or not the respective record groups selected satisfy the predetermined congestion condition in the same manner as the above.

That is, regarding the respective record groups selected based upon the selection conditions (“sex=female and age=older”, “sex=male and age=older”, “sex=female and weather=snow”, “sex=male and weather=snow”, and “age=older and weather=snow”), the congestion state determining unit 12 first calculates respective numbers of records, respective center of gravity, respective congestion degrees and the like. The results are shown in the following Table 2.

TABLE 2

| | | | sum of | |
|---|---|---|---|---|
| Combination of | | | squares of | |
| attribute | number | | distance | |
| information | of | center of | from center | congestion |
| pieces | records | gravity | of gravity | degree |
| “sex = female and | 5 | (2.6, 3.6) | 16.4 | 8.2 |
| age = older” | | | | |
| “sex = male and | 5 | (7, 4.6) | 53.2 | 10.64 |
| age = older” | | | | |
| “sex = female and | 2 | (4, 3.5) | 0.5 | 0.25 |
| weather = snow” | | | | |
| “sex = male and | 1 | (5, 3) | 0.0 | — |
| weather = snow” | | | | |
| “age = older and | 3 | (4.33, 3.33) | 1.33 | 0.44 |
| weather = snow” | | | | |

From Table 2, it is understood that the number of the combinations of attribute information pieces where the congestion degree is 12.5 or less and the number of records is 2 or more, namely the number of the combinations of attribute information pieces satisfying the congestion condition is four of “sex=female and age=older”, “sex=male and age=older”, “sex=female and weather=snow”, and “age=older and weather=snow”. Therefore, the four combinations of attribute information pieces and data items (the number of records, center of gravity, sum of squares of distance from center of gravity, and congestion degree) corresponding thereto are stored as selection conditions in the congestion state determining unit 12. The combinations of attribute information pieces (the selection conditions) stored are passed to the selection condition composing unit 13 shown in FIG. 1.

The selection condition composing unit 13 combines the four combinations of attribute information pieces (the selection conditions) passed and the previously (first) passed attribute information piece which is “sex=female”, “sex=male”, “age=older”, or “weather=snow”) such that the former and the latter do not overlap with each other. As a result, two new combinations of attribute information pieces (selection conditions) i.e. “sex=female, age=older, and weather=snow” and “sex=male, age=older, and weather=snow” are generated.

The generated two combinations of attribute information pieces (selection conditions) are passed from the selection condition composing unit 13 to the data selecting unit 11, and the data selecting unit 11 selects records from the traffic accident occurrence record data shown in FIG. 15 based upon respective selection conditions received.

Determination is made in the congestion state determining unit 12 shown in FIG. 1 about whether or not the respective record groups selected based upon the selection conditions (“sex=female, age=older, and weather=snow” and “sex=male, age=older, and weather=snow”) satisfy the predetermined congestion condition in the same manner as the above.

That is, first, the congestion state determining unit 12 calculates the number of records, the center of gravity, the congestion degree, and the like regarding each of the record groups selected based upon the selection conditions (“sex=female, age=older, and weather=snow” and “sex=male, age=older, and weather=snow”). The results are shown in the following Table 3.

TABLE 3

| | | | sum of | |
|---|---|---|---|---|
| | | | squares of | |
| Combination of | number | center | distance | |
| attribute | of | of | from center | congestion |
| information pieces | records | gravity | of gravity | degree |
| “sex = female, | 2 | (4, 3.5) | 0.5 | 0.25 |
| age = older, and | | | | |
| weather = snow” | | | | |
| “sex = male, | 1 | (5, 3) | 0.0 | — |
| age = older, and | | | | |
| weather = snow” | | | | |

From Table 3, it is understood that the combination of attribute information pieces where the congestion degree is 12.5 or less and the number of records is 2 or more, namely, the combination of attribute information pieces satisfying the predetermined congestion condition is only one of “sex=female, age=older, and weather=snow”. The combination of attribute information pieces (a selection condition) and data pieces (the number of records, the center of gravity, the sum of squares of distance from center of gravity, and the congestion degree) corresponding thereto are stored in the congestion state determining unit 12. The combination of attribute information pieces stored is passed to the selection condition composing unit 13 shown in FIG. 1.

The selection condition composing unit 13 determines that there is not any more attribute information pieces to be combined regarding the selection condition passed (if the selection condition is combined with any attribute information piece, same attributes is overlapped) and outputs a termination instruction of processing to the congestion state determining unit 12.

When the congestion state determining unit 12 receives the termination instruction of processing, it outputs the attribute information pieces, the combinations of attribute information pieces stored and the like. The attribute information pieces, the combinations of attribute information pieces and the like outputted are shown in the following Table 4.

TABLE 4

| Attribute | | | | |
|---|---|---|---|---|
| information piece | | | sum of | |
| or combination of | | | squares of | |
| attribute | number | | distance | |
| information | of | center of | from center | congestion |
| pieces | records | gravity | of gravity | degree |
| “sex = female” | 10 | (2.4, 5.7) | 74.5 | 7.45 |
| “sex = male” | 10 | (7.3, 5.1) | 101.0 | 10.1 |
| “age = older” | 10 | (4.8, 4.1) | 120.5 | 12.05 |
| “weather = snow” | 3 | (4.33, 3.33) | 1.33 | 0.44 |
| “sex = female and | 5 | (2.6, 3.6) | 16.4 | 8.2 |
| age = older” | | | | |
| “sex = male and | 5 | (7, 4.6) | 53.2 | 10.64 |
| age = older” | | | | |
| “sex = female and | 2 | (4, 3.5) | 0.5 | 0.25 |
| weather = snow” | | | | |
| “age = older and | 3 | (4.33, 3.33) | 1.33 | 0.44 |
| weather = snow” | | | | |
| “sex = female, | 2 | (4, 3.5) | 0.5 | 0.25 |
| age = older, and | | | | |
| weather = snow” | | | | |

In order to obtain the results shown in Table 4, the number of attribute information pieces or the number of the combinations of attribute information pieces which were determined about whether or not satisfying the predetermined congestion condition reaches 14 as a total of 7 at the first time, 5 at the second time, and 2 at the third time. In the embodiment, therefore, the attribute information pieces and the combination of attribute information pieces satisfying the congestion condition can be found by an amount of calculation reduced as compared with that the conventional method which makes determination about 35 cases corresponding to all the attribute information pieces and all the combinations thereof.

In the embodiment, even if a first attribute information piece which does not satisfy the congestion condition is contained regarding a certain attribute, when a second attribute information piece satisfying the congestion condition is present regarding the certain attribute, the second attribute information piece and the combination of attribute information pieces including the second attribute information piece and satisfying the congestion condition can be found. In this embodiment, for example, there are three information pieces of “fair”, “rainy” and “snow” as the attribute information pieces for the weather. The attribute information pieces “fair” and “rainy” of these information pieces do not satisfy the congestion condition (the congestion degree is larger than 12.5), but the attribute information piece “snow” satisfies the congestion condition, so that the attribute information piece “snow” and the combination of attribute information pieces including the “snow” and satisfying the congestion condition can be found.

The attribute information pieces and the combinations of attribute information pieces, the centers of gravity, the congestion degrees, and the like thus obtained can be used for various applications.

For example, it is understood from Table 4, line 7 (sex=female and weather=snow) that a woman tends to cause a traffic accident during snow in the vicinity of the center of gravity (4, 3.5). Accordingly, it is proposed that a sign board promoting awareness, such as “care to slippage” is provided for women around the center of gravity. Since the congestion degree is as small as “0.25” (tendency of congestion is large), with regard to the range where the sign board is provided, such determination can be made that the sign board can be provided within a distance relatively near the center of gravity (4, 3.5).

In the above explanation, the traffic accident occurrence record data is used as the analysis target data example. However, it is possible to use various spatial data including position information. For example, an effective sales strategy can be planed by analyzing data including a position where a taxi catches a passenger as the position information to calculate a place where passengers gather for each sex, for each time band, or the like.

In the selection condition composing unit 13 shown in FIG. 1, when the selection conditions (the attribute information pieces, and the combination of attribute information pieces) are combined to generate a combination of attribute information pieces, if it is predicted in advance that the generated combination of attribute information pieces does not satisfy the congestion condition, it is preferable in view of reduction of a calculation amount that the combination is not generated.

Here, before combining, if a combination of attribute information pieces is generated, a prediction about whether or not the combination of attribute information pieces satisfies the congestion condition may be performed. For example, that is performed by obtaining centers of gravity about respective record groups including respective subjects to be combined to determine about whether or not a square of a distance between the centers of gravity satisfies a criteria based upon a predetermined threshold.

For example, in the above-described second processing, before four attribute information pieces of
“sex=female” (the number of records: 10, the center of gravity: (2.4, 5.7), and the congestion degree: 7.45)
“sex=male” (the number of records: 10, the center of gravity: (7.3, 5.1), and the congestion degree: 10.1)
“age=older” (the number of records: 10, the center of gravity (4.8, 4.1), and the congestion degree: 12.05)
“weather=snow” (the number of records: 3, the center of gravity (4.33, 3.33), and the congestion degree: 0.44)
   are combined, the squares of a distance between centers of gravity are calculated. When the calculated value is 10 (a predetermined threshold) or more, it is determined that two attribute information pieces are far from each other so that the combination of the two attribute information pieces is not generated.

Therefore, when squares of a distance between centers of gravity are calculated regarding the above four attribute information pieces, the following results are obtained.
“sex=female and age=older” (square of distance between centers of gravity: 8.32)
“sex=male and age=older” (square of distance between centers of gravity: 7.25)
“sex=female and weather=snow” (square of distance between centers of gravity: 9.35)
“sex=male and weather=snow” (square of distance between centers of gravity: 11.95)
“age=older and weather=snow” (square of distance between centers of gravity: 0.81)

Since the square of the distance between centers of gravity is 10 (a predetermined threshold) or more (11.95) regarding the combination of “sex=male and weather=snow”, it is determined that the combination is not generated. As a result, a processing for selecting records including “sex=male and weather=snow” from the traffic accident occurrence record data (refer to FIG. 15) and a processing for making determination about whether or not the selected records (record group) satisfies the congestion condition are omitted. Thereby, the calculation amount can further be reduced.

In the embodiment described above, the processing step shown in FIG. 2 can be realized by hardware, and it may be realized by executing a software. The software may be stored into a storage media.

In the embodiment described above, explanation has been made using the two-dimensional space as one example, but the present invention is applicable to a three or more-dimensional space.

What is claimed is:

1. A spatial data analyzing apparatus which, from a plurality of records each record including position information showing a position in a two or more-dimensional space and a plurality of attribute information pieces belonging to a plurality of attributes, finds a condition of attribute information under which records are congested in the space, comprising:
a first data selecting unit which selects records having same attribute information piece from the plurality of records for each of attribute information pieces;
a first determining unit which stores the attribute information piece corresponding to the records selected in case where the records selected satisfy a predetermined congestion condition based on the position information of the records selected;
a combination data generating unit which combines attribute information pieces stored among different attributes to generate a combination of attribute information pieces;
a second data selecting unit which selects records having the combination of attribute information pieces from the plurality of records; and
a second determining unit which stores the combination of attribute information pieces corresponding to the records selected by the second data selecting unit in case where the records selected satisfy the predetermined congestion condition based on the position information of the records selected.

2. A spatial data analyzing apparatus according to claim 1, wherein the combination data generating unit combines the combination of attribute information pieces stored by the second determining unit and the attribute information piece stored by the first determining unit to generate a new combination of attribute information pieces.

3. A spatial data analyzing apparatus according to claim 2, wherein the combination data generating unit generates the new combination of attribute information pieces by combining the combination of attribute information pieces with the attribute information piece belonging to attribute which is not included in the combination of attribute information pieces.

4. A spatial data analyzing apparatus according to claim 1, further comprising:
a center-of-gravity calculating unit calculating a center of gravity of the records selected, based on the position information of the records selected; and
a congestion degree calculating unit calculating a congestion degree of the records selected, based on the center of gravity calculated and the position information of the selected records;
wherein the first and second determining unit determines whether or not the predetermined congestion condition is satisfied according to whether or not the congestion degree calculated satisfies a predetermined criteria.

5. A spatial data analyzing apparatus according to claim 4, wherein the congestion degree calculating unit treats a value obtained by dividing sum of squares of distances from the center of gravity calculated to the records selected by the number of the records selected, as the congestion degree.

6. A spatial data analyzing apparatus according to claim 1, wherein the combination data generating unit, before generating the combination of attribute information pieces, calculates centers of gravity of the records selected for respective subjects to be combined based on the position information of the records selected for respective subjects, and generates the combination of attribute information pieces in case where a distance between the centers of gravity satisfies a predetermined criteria.

7. A spatial data analyzing apparatus according to claim 2, wherein the combination data generating unit, before generating the combination of attribute information pieces, calculates centers of gravity of the records selected for respective subjects to be combined based on the position information of the records selected for respective subjects, and generates the combination of attribute information pieces in case where a distance between the centers of gravity satisfies a predetermined criteria.

8. A spatial data analyzing method which, from a plurality of records each record including position information showing a position in a two or more-dimensional space and a plurality of attribute information pieces belonging to a plurality of attributes, finds a condition of attribute information under which records are congested in the space, comprising:
selecting records having same attribute information piece from the plurality of records for each of attribute information pieces;
storing the attribute information piece corresponding to the records selected in case where the records selected satisfy a predetermined congestion condition based on the position information of the records selected;
combining attribute information pieces stored among different attributes to generate a combination of attribute information pieces;
selecting records having the combination of attribute information pieces from the plurality of records; and
storing the combination of attribute information pieces corresponding to the records selected in case where the records selected satisfy the predetermined congestion condition based on the position information of the records selected.

9. A spatial data analyzing method according to claim 8, further comprising:
combining the combination of attribute information pieces stored and the attribute information piece stored to generate a new combination of attribute information pieces;
selecting records having the new combination of attribute information pieces from the plurality of records;
storing the new combination of attribute information pieces corresponding to the records selected in case where the records selected satisfy the predetermined congestion condition based on the position information of the records selected; and
repeating the combining, the selecting, and the storing in this order.

10. A spatial data analyzing method according to claim 9, further comprising generating the new combination of attribute information pieces by combining the combination of attribute information pieces with the attribute information piece belonging to attribute which is not included in the combination of attribute information pieces.

11. A spatial data analyzing method according to claim 9, wherein, in case where the new combination of attribute information pieces stored includes all kinds of attributes, the repeating is terminated.

12. A spatial data analyzing method according to claim 9, wherein, in case where the record selected which satisfies the predetermined congestion condition is not present, the repeating is terminated.

13. A spatial data analyzing method according to claim 8, further comprising:
calculating a center of gravity of the records selected based on the position information of the records selected;
calculating a congestion degree of the records selected based on the center of gravity calculated and the position information of the records selected; and
determining whether or not the predetermined congestion condition is satisfied according to whether or not the congestion degree calculated satisfies a predetermined criteria.

14. A spatial data analyzing method according to claim 13, wherein a value obtained by dividing sum of squares of distances from the center of gravity calculated to the records selected by the number of the records selected is treated as the congestion degree.

15. A spatial data analyzing method according to claim 8, wherein, before generating the combination of attribute information pieces, centers of gravity of the records selected for respective subjects to be combined are calculated based on the position information of the records selected for respective subjects, and the combination of attribute information pieces is generated in case where a distance between the centers of gravity satisfies a predetermined criteria.

16. A spatial data analyzing method according to claim 9, wherein, before generating the combination of attribute information pieces, centers of gravity of the records selected for respective subjects to be combined are calculated based on the position information of the records selected for respective subjects, and the combination of attribute information pieces is generated in case where a distance between the centers of gravity satisfies a predetermined criteria.

17. A spatial data analyzing program which, from a plurality of records each record including position information showing a position in a two or more-dimensional space and a plurality of attribute information pieces belonging to a plurality of attributes, finds a condition of attribute information under which records are congested in the space, the spatial data analyzing program causing a computer to execute:
a first data selecting step selecting records having same attribute information piece from the plurality of records for each of attribute information pieces;
a first determining step storing the attribute information piece corresponding to the records selected in case where the records selected satisfy a predetermined congestion condition based on the position information of the records selected;
a combination data generating step combining attribute information pieces stored among different attributes to generate a combination of attribute information pieces;
a second data selecting step selecting records having the combination of attribute information pieces from the plurality of records; and
a second determining step storing the combination of attribute information pieces corresponding to the records selected by the second data selecting step in case where the records selected satisfy the predetermined congestion condition based on the position information of the records selected.

18. A spatial data analyzing program according to claim 17, further causing the computer to execute:
a re-generation step combining the combination of attribute information pieces stored by the second determining step and the attribute information piece stored by the first determining step to generate a new combination of attribute information pieces;
a third data selecting step selecting records having the new combination of attribute information pieces from the plurality of records;
a third determining step storing the new combination of attribute information pieces corresponding to the records selected by the third data selecting step in case where the records selected satisfy the predetermined congestion condition based on the position information of the records selected; and
a repeating step repeating the re-generation step, the third data selecting step, and the third determining step in this order.

19. A spatial data analyzing program according to claim 17, further causing the computer to execute:
a center-of-gravity calculating step calculating a center of gravity of the records selected, based on the position information of the records selected; and
a congestion degree calculating step calculating a congestion degree of the records selected, based on the center of gravity calculated and the position information of the selected records;
wherein the first and second determining step include a step determining whether or not the predetermined congestion condition is satisfied according to whether or not the congestion degree calculated satisfies a predetermined criteria.

20. A spatial data analyzing program according to claim 17, wherein the combination data generating step includes, before generating the combination of attribute information pieces, a step calculating centers of gravity of the records selected for respective subjects to be combined based on the position information of the records selected for respective subjects, and a step generating the combination of attribute information pieces in case where a distance between the centers of gravity satisfies a predetermined criteria.
